(19) United States
(12) Patent Application Publication
(10) Pub. No.: US 2026/0270181 A1
(43) Pub. Date: Sep. 10, 2026

(54) DETERMINING TRACEROUTES USING TCP PACKETS

(71) Applicant: Charter Communications Operating, LLC, St. Louis, MO (US)

(72) Inventor: Robert B. Hulshof, Highlands Ranch, CO (US)

(73) Assignee: Charter Communications Operating, LLC, St. Louis, MO (US)

(21) Appl. No.: 19/074,761

(22) Filed: Mar. 10, 2025

(51) Int. Cl. H04L 43/10

(52) U.S. Cl. CPC H04L 43/10; H04L 45/20

(57) ABSTRACT

To determine a path traceroute, after a connection between the path's source and destination nodes has been established, the source node transmits a set of traceroute packets having different time-to-live (TTL) values and different payloads to prevent hops from dropping different traceroute packets having identical payloads. In a communication network that supports TCP and ICMP protocols, the traceroute packets are TCP data packets, timeout packets from the hops are ICMP timeout packets, and acknowledgment packets from the destination node are TCP ACK packets.

### BACKGROUND

### Field of the Disclosure

The present disclosure relates to communication networks and, more specifically but not exclusively, to techniques for determining traceroutes of paths in communication networks.

### Description of the Related Art

This section introduces aspects that may help facilitate a better understanding of the disclosure. Accordingly, the statements of this section are to be read in this light and are not to be understood as admissions about what is prior art or what is not prior art.

The term “traceroute” refers to the sequence of hops (i.e., intermediate nodes) through which packets flow in a path from a source node to a destination node in a communication network. The determination of traceroutes enables pinpointing which hop or hops cause excessive latencies, which information may be useful in managing network data flows. The typical method to trace a network path is to send a sequence of traceroute packets (also referred to as echo or ping packets) from the source node towards the destination node with each traceroute packet having a different time-to-live (TTL) value and a unique sequence number in its Internet Protocol (IP) header.

As known to those skilled in the art, as a packet traverses a hop, the hop will decrement the TTL value in the packet's IP header. A hop that receives a packet having a TTL value of 1 (one) will not forward the packet towards the destination node, but will instead transmit a “timeout” packet back to the source node identifying that hop and the received packet's unique sequence number in the IP header of the timeout packet in order to inform the source node that its transmitted packet never reached the destination node.

By transmitting, along a particular path, a sequence of traceroute packets having TTL values of 1, 2, 3, etc., respectively, up to a TTL value larger than the expected maximum number of hops in the network's paths, the source node will be able to determine the particular path's traceroute by keeping track of the hops that transmitted timeout packets in response to different traceroute packets.

### SUMMARY

One typical method for generating traceroutes is to use traceroute packets that conform to the Internet Control Message Protocol (ICMP). ICMP packets are sometimes routed differently from packets that conform to the Transmission Control Protocol (TCP). As such, it is also useful to implement the traceroute technique using TCP packets in order to determine a more-representative network path for routine TCP data packets. The typical way to implement the traceroute technique using the TCP protocol is to send a sequence of TCP Synchronize Sequence Number (aka SYN) packets as traceroute packets with different TTL values in the IP headers of the different TCP SYN packets. As known to those skilled in the art, as a TCP SYN packet traverses a hop, the hop will decrement the TTL value. A hop that receives a TCP SYN packet having a TTL value of 1 will drop the packet and instead transmit an ICMP timeout packet back to the source node. On the other hand, when the destination node receives a TCP SYN packet, the destination node will transmit a TCP SYN acknowledgement (SYN/ACK) packet back to the source node. Note that, when the sequence of TCP SYN packets includes multiple TCP SYN packets having original TTL values that are greater than the number of hops in the path, the destination node may receive those multiple TCP SYN packets and transmit multiple corresponding SYN/ACK packets back to the source node. In any case, the source node will be able to determine the traceroute from the different, received timeout and SYN/ACK packets.

One problem with such a traceroute technique is that some layer-4 devices may employ firewalls that drop TCP packets that the layer-4 device determines to be duplicates of previously received TCP packets. As such, if one or more hops in a path being traced employ such a firewall, then such a hop may drop TCP SYN traceroute packets that the hop determines to be duplicates of a previously received TCP SYN traceroute packet, thereby thwarting the traceroute technique. In particular, a duplicate-dropping hop that receives a first of two or more TCP SYN traceroute packets having different TTL values may determine that the one or more subsequently received TCP SYN traceroute packets are duplicates of the first packet and drop those subsequently received packets, thereby preventing the traceroute from being determined.

Problems in the prior art are addressed in accordance with the principles of the present disclosure by using TCP data packets having uniquely different payloads as traceroute packets instead of using TCP SYN packets as traceroute packets to determine the traceroute of a particular network path. By ensuring that the payloads are different, a hop that employs a duplicate-packet-dropping firewall will not determine that different TCP data packets used as traceroute packets are duplicates of one another and will instead allow them to pass on to the subsequent path hop as appropriate for traceroute determination.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a block diagram of a path in a TCP communication network, according to certain embodiments of the present disclosure; and

FIG. 2 is a simplified hardware block diagram of an example node that can be used to implement any of the nodes of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

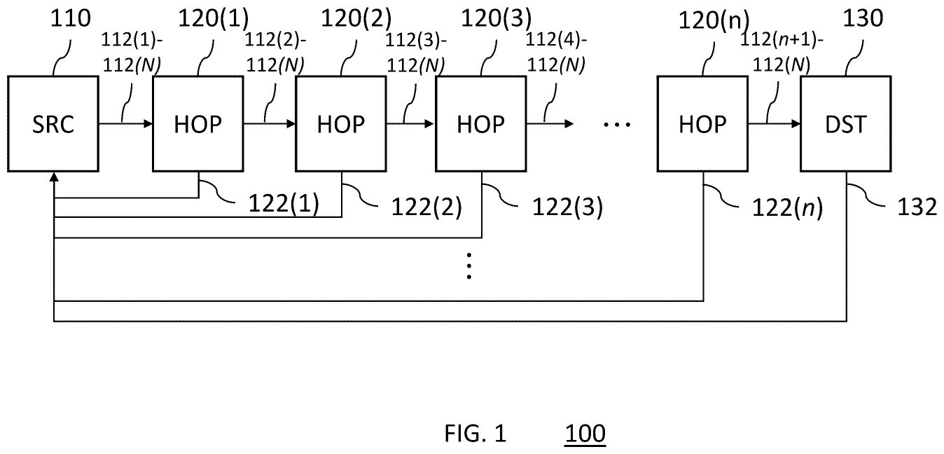

FIG. 1 is a block diagram of a path 100 in a TCP communication network, according to certain embodiments of the present disclosure. As shown in FIG. 1, the path 100 comprises a source node (SRC) 110 connected to a destination node (DST) 130 via a set of n intermediate nodes (hops) 120(1)-120(n).

To determine the traceroute of the path 100, the source node 110 completes the TCP 3-way handshake sequence with the destination node 130, to establish a TCP connection between those two nodes. The source node 110 then transmits towards the destination node 130 along the path 100 a set of TCP data packets 112(1)-112(N) having corresponding TTL values of 1-N, respectively, and uniquely different payloads as TCP traceroute packets within the established TCP connection, where the number N of TCP data packets 112 is greater than the expected number n of hops 120 in the path 100. Note that the source node 110 can transmit those N TCP data packets 112 in any order and with any relative timing.

In particular, the set of N TCP data packets 112(1)-112(N) includes:
A TCP data packet 112(1) having an initial TTL value of 1 and a unique payload (i.e., different from the payloads of the other (N−1) TCP data packets 112);
A TCP data packet 112(2) having an initial TTL value of 2 and a unique payload;
A TCP data packet 112(3) having an initial TTL value of 3 and a unique payload; and
And so on up to a TCP data packet 112(N) having an initial TTL value of N and a unique payload.

When the TCP data packet 112(1) arrives at the hop 120(1), the hop 120(1) will determine that the TTL value is 1, drop the first TCP data packet 112(1), and transmit back to the source node 110 an ICMP timeout packet 122(1) identifying the hop 120(1) and the TCP data packet 112(1). Note that the path traversed by the timeout packet 122(1) may be different from the path 100.

When the TCP data packet 112(2) arrives at the hop 120(1), the hop 120(1) will determine that the TTL value is 2, decrement the TTL value to 1, and forward the TCP data packet 112(2) to the hop 120(2). Note that, because the payload of the TCP data packet 112(2) is different from the payloads of all the other TCP data packets 112, the hop 120(1) will not drop the TCP data packet 112(2), even if the TCP data packet 112(2) arrives at the hop 120(1) after other TCP data packets 112.

When the TCP data packet 112(2) arrives at the hop 120(2), the hop 120(2) will determine that the TTL value is 1, drop the TCP data packet 112(2), and transmit back to the source node 110 an ICMP timeout packet 122(2) identifying the hop 120(2) and the TCP data packet 112(2). Note that the path traversed by the timeout packet 122(2) may be different from the path 100 and/or different from the path traversed by the other timeout packet 122.

When the TCP data packet 112(3) arrives at the hop 120(1), the hop 120(1) will determine that the TTL value is 3, decrement the TTL value to 2, and forward the TCP data packet 112(3) to the hop 120(2). Note that, because the payload of the TCP data packet 112(3) is different from the payloads of all the other TCP data packets 112, the hop 120(1) will not drop the TCP data packet 112(3), even if the TCP data packet 112(3) arrives at the hop 120(1) after other TCP data packets 112.

When the TCP data packet 112(3) arrives at the hop 120(2), the hop 120(2) will determine that the TTL value is 2, decrement the TTL value to 1, and forward the TCP data packet 112(3) to the hop 120(3). Note that, because the payload of the TCP data packet 112(3) is different from the payloads of all the other TCP data packets 112, the hop 120(2) will not drop the TCP data packet 112(3), even if the TCP data packet 112(3) arrives at the hop 120(2) after other TCP data packets 112.

When the TCP data packet 112(3) arrives at the hop 120(3), the hop 120(3) will determine that the TTL value is 1, drop the TCP data packet 112(3), and transmit back to the source node 110 an ICMP timeout packet 122(3) identifying the hop 120(3) and the TCP data packet 112(3). Note that the path traversed by the timeout packet 122(3) may be different from the path 100 and/or different from the paths traversed by the other timeout packets 122.

Analogous processing applies to the rest of the TCP data packets 112 up to the TCP data packet 112(n) which leaves the source node 110 with an initial TTL value of n and arrives at the last hop 120(n) with a TTL value of 1. As such, the hop 120(n) will determine that the TTL value is 1, drop the TCP data packet 112(n), and transmit back to the source node 110 an ICMP timeout packet 122(n) identifying the hop 120(n) and the TCP data packet 112(n). Note that the path traversed by the timeout packet 122(n) may be different from the path 100 and/or different from the paths traversed by the other timeout packets 122.

The TCP data packet 112(n+1) leaves the source node 110 with a TTL value of (n+1) and arrives at the destination node 130 with a TTL value of 1. In response, the destination node 130 will transmit back to the source node 110 a TCP ACK packet 132 identifying the destination node 130 and the TCP data packet 112(n+1). Note that the path traversed by the TCP ACK packet 132 may be different from the path 100 and/or different from the paths traversed by the timeout packets 122.

Similarly, the other (N−n−2) TCP data packets 112 that leave the source node 110 with a TTL value greater than (n+1) will arrive at the destination node 130 with a TTL value greater than 1. Here, too, in response, the destination node 130 will transmit back to the source node 110 another TCP ACK packet 132 identifying the destination node 130 and the corresponding TCP data packet 112.

After receiving all n of the ICMP timeout packets 122(1)-122(n) and all (N−n) TCP ACK packets 132, the source node 110 will have all the information needed to determine the traceroute of the path 100. The source node 110 can then exchange a connection termination sequence with the destination node 130, to close the TCP connection.

Although the present disclosure has been described in the context of a communication network that supports both TCP and ICMP protocols, where the traceroute packets are TCP data packets, the timeout packets are ICMP timeout packets, and the acknowledgment packets are TCP ACK packets, those skilled in the art will understand that the disclosure encompasses embodiments in which the communication network supports other suitable transmission protocols where hops may drop different traceroute packets having identical payloads.

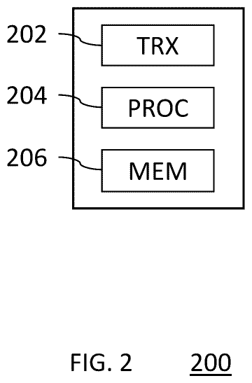

FIG. 2 is a simplified hardware block diagram of an example node 200 that can be used to implement any of the nodes 110, 120, and 130 of FIG. 1. As shown in FIG. 2, the node 200 includes (i) communication hardware (e.g., wireless, wireline, and/or optical transceivers (TRX)) 202 that supports communications with other nodes, (ii) one or more processors (e.g., CPU and/or GPU microprocessors) 204 that control the operations of the node 200 and/or process data within the node 200, and (iii) one or more memories (e.g., RAM, ROM) 206 that store code executed by the processors 204 and/or data generated and/or received by the node 200.

In certain embodiments, the present disclosure is an apparatus comprising a source node for determining a traceroute of a path from the source node via a set of one or more hops to a destination node in a communication network. The source node comprises a memory and at least one processor, coupled to the memory and operative to (i) transmit a set of traceroute packets having different TTL values and different payloads towards the destination node along the path; (ii) receive, from each hop in the path, a timeout packet identifying the hop and a corresponding traceroute packet; (iii) receive, from the destination node, at least one ACK packet identifying the destination node and a corresponding traceroute packet; and (iv) determine the traceroute from each timeout packet and the at least one ACK packet.

In at least some of the above embodiments, the communication network supports TCP protocol; each traceroute packet is a TCP data packet; and each ACK packet is a TCP ACK packet.

In at least some of the above embodiments, each timeout packet is an ICMP timeout packet.

In at least some of the above embodiments, the apparatus further comprises the one or more hops.

In at least some of the above embodiments, the apparatus further comprises the destination node.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for determining a traceroute of a path from a source node via a set of one or more hops to a destination node in a communication network, the method comprising the source node:
transmitting a set of traceroute packets having different time-to-live (TTL) values and different payloads towards the destination node along the path;
receiving, from each hop in the path, a timeout packet identifying the hop and a corresponding traceroute packet;
receiving, from the destination node, at least one acknowledgment (ACK) packet identifying the destination node and a corresponding traceroute packet; and
determining the traceroute from each timeout packet and the at least one ACK packet.

2. The method of claim 1, wherein:
the communication network supports Transport Control Protocol (TCP);
each traceroute packet is a TCP data packet; and
each ACK packet is a TCP ACK packet.

3. The method of claim 2, wherein each timeout packet is an Internet Control Message Protocol (ICMP) timeout packet.

4. Apparatus comprising a source node for determining a traceroute of a path from the source node via a set of one or more hops to a destination node in a communication network, the source node comprising:
a memory; and
at least one processor, coupled to the memory and operative to:
transmit a set of traceroute packets having different TTL values and different payloads towards the destination node along the path;
receive, from each hop in the path, a timeout packet identifying the hop and a corresponding traceroute packet;
receive, from the destination node, at least one ACK packet identifying the destination node and a corresponding traceroute packet; and
determine the traceroute from each timeout packet and the at least one ACK packet.

5. The apparatus of claim 4, wherein:
the communication network supports TCP protocol;
each traceroute packet is a TCP data packet; and
each ACK packet is a TCP ACK packet.

6. The apparatus of claim 5, wherein each timeout packet is an ICMP timeout packet.

7. The apparatus of claim 4, further comprising the one or more hops.

8. The apparatus of claim 7, further comprising the destination node.
